(19) United States
(12) Patent Application Publication
(10) Pub. No.: US 2017/0124552 A1
(43) Pub. Date: May 4, 2017

(54) METHOD AND SERVER FOR PAYING COMMODITY USING DEVICE

(71) Applicant: SK PLANET CO., LTD., Seongnam-si Gyeonggi-do (KR)

(72) Inventor: Gi Dong LEE, Seoul (KR)

(21) Appl. No.: 15/209,769

(22) Filed: Jul. 14, 2016

(30) Foreign Application Priority Data
Oct. 29, 2015 (KR) 10-2015-0150979

(51) Int. Cl. G06Q 20/32; G06Q 30/02; G06Q 10/08; G06Q 30/06

(52) U.S. Cl. CPC G06Q 20/3276; G06Q 30/0635; G06Q 30/0226; G06Q 10/083

(57) ABSTRACT

Disclosed herein is a method for paying a commodity using a device. The method may include the steps of (a) obtaining commodity information by scanning barcode of a commodity, (b) recognizing a first gesture of a user, (c) sending the obtained commodity information to a server in response to the recognized first gesture, and (d) receiving purchase information about the commodity whose commodity information has been obtained from the server and outputting the purchase information. There is an advantage in that a user can easily purchase a commodity without renting a cart because a gesture of the user who selects a commodity through the device can be automatically selected, the commodity can be put in a shopping basket, and payment for the commodity can be performed. In paying a commodity, additional information, such as a corresponding coupon and membership points applied to the commodity, can be provided to a user. Accordingly, a substantial help can be provided in the purchase of a commodity, and a company which provides corresponding information can have a kind of marketing effect.

### CROSS REFERENCE TO RELATED APPLICATION

The present application claims the benefit of Korean Patent Application No. 10-2015-0150979 filed in the Korean Intellectual Property Office on Oct. 29, 2015, the entire contents of which are incorporated herein by reference.

### BACKGROUND OF THE INVENTION

1. Technical Field

The present invention relates to a method and server for paying a commodity using a device and, more particularly, to a method and apparatus capable of recognizing a user's gesture and putting a commodity in a shopping basket.

2. Description of the Related Art

A wearable device means a device capable of being worn on the human body literally. The wearable device includes various types, such as glasses, a watch, a bracelet, shoes, a ring, a belt, a band, a necklace, a headset, and clothes, depending on a portion on which the wearable device is worn. Such a wearable device is rapidly spread. Wearable glasses, a wearable watch and wearable band which are very closely related to human life and can be easily worn form the most product group.

The wearable device is also called a smart device. The reason for this is that the driving of the wearable device needs to be started up by a user input, but once the wearable device is driven, it can automatically generate various types of additional information and provide them to a user. For example, if a user who has worn a wearable watch wants to measure his or her heart rate, he or she presses a heart rate measurement input button. At the same time, the wearable watch may measure the user's heart rate, may generate various types of information based on the measured heart rate, and may provide them to the user. Recently, many wearable devices that do not require the startup of driving by a user input are appearing. For example, a wearable band may continue to measure a user's heart rate although there is no startup of driving by a user input. There is a good possibility that the future wearable device not requiring the startup of driving by a user input will be developed. The reason for this is that convenience in device driving is increased because a user input is not required.

The root of various types of additional information provided from such a wearable device to a user includes information measured from the user. For example, the root includes pieces of information, such as the heart rate, blood pressure, mental state, weight, body temperature, inhaling capacity, number of steps, gesture, matter of concern, and current location of a user. Accordingly, sensors for measuring various types of information about a user need to be mounted on a wearable device. As the type of sensors mounted on a wearable device is increased, many pieces of information about a user may be measured. For this reason, a heart rate measurement sensor, a global positioning system (GPS) sensor, and a step number measurement sensor tend to be essentially mounted on a recent wearable device. Research for mounting various sensors on a limited device continues to be carried out.

The wearable device may measure information about a user through a mounted sensor, may generate various types of additional information based on the measurement information, and may provide them to the user. For example, the wearable device may measure blood pressure of a user and may provide information about a medicine capable of lowering the blood pressure to a proper level if the measured blood pressure is too high. Furthermore, the wearable device may measure the current location of a user and may provide the user with information about nearby stores or products related to the user's interest. Such additional information may be provided through the function of the wearable device itself. Recently, an application that is installed on a wearable device is also developed because a single wearable device is unable to provide all of pieces of additional information for different users. In this case, the application may be considered to be a kind of application program. The application may function to generate various types of additional information based on information measured through the function of the wearable device itself and provide them. In the above example, the information about a medicine capable of lowering blood pressure to a proper level or the information about nearby stores or products related to a user's interest may be performed by an application. That is, whenever a new application is developed, additional information which may be provided to a user through a wearable device become various. The development of an application may be considered to be a forward partner along with the development of a wearable device itself.

The wearable device may make a user uneasy in control of the wearable device unlike a portable device, such as a common smart phone, because it needs to be worn on the body of the user. For example, smart glasses need to be worn on a face. A corresponding user is unable to check an input button with an eye and has to press a button through memory that the button was previously pressed, feeling or estimation. Accordingly, recently, there is an attempt to control a wearable device itself by recognizing a movement, action or gesture of a user through a action recognition sensor mounted on the wearable device. Research for a service capable of being provided through such control of the wearable device continues to be carried out.

Accordingly, this specification proposes a new and advanced method and server, which are capable of providing a service for easily putting a commodity, selected when a user purchases the commodity, in a shopping basket and for performing settlement through a action recognition sensor mounted on a wearable device and of obtaining a specific marketing effect.

### PRIOR ART DOCUMENT

### Patent Document

(Patent Document 1) Korean Patent No. 10-1426517 (Jul. 29, 2014)

### SUMMARY OF THE INVENTION

An object of the present invention is to provide a method and server capable of easily putting a commodity, selected when a user purchases the commodity, in a shopping basket and performing settlement through a wearable device.

Another object of the present invention is to provide a method and server capable of obtaining a specific marketing effect.

Technical objects to be achieved by the present invention are not limited to the objects, and they may include various technical objects within a range evident to those skilled in the art from the following description.

In accordance with a first embodiment of the present invention, a method for paying a commodity using a device may include the steps of (a) obtaining commodity information by scanning barcode of a commodity, (b) recognizing a first gesture of a user, (c) sending the obtained commodity information to a server in response to the recognized first gesture, and (d) receiving purchase information about the commodity whose commodity information has been obtained from the server and outputting the purchase information.

Furthermore, the first gesture may include a gesture which has been previously set and stored and which is indicative of an expression of the user's intentions of adding the commodity to a shopping basket.

Furthermore, the method may further include the steps of (c-1) adding, by the server, the commodity whose commodity information has been obtained to the shopping basket of the user after the step (c) and (c-2) outputting the shopping basket of the user.

Furthermore, the purchase information may include information about one or more of the name, price, selling place, purchase quantity, applied coupon, and applied membership points of the commodity.

Furthermore, the method may further include the step of (e) recognizing, by a device, a second gesture of the user after the step (d).

Furthermore, the second gesture may include a gesture which has been previously set and stored and which is indicative of an expression of the user's intentions of deleting the commodity from the shopping basket.

Furthermore, the method may further include the step of (e-1) deleting, by the server, the commodity whose commodity information has been obtained from the shopping basket of the user after the step (e).

Furthermore, the method may further include the steps of (f) receiving a payment request from the user after the step (d) and (g) sending the payment request for the commodity whose purchase information has been obtained to the server.

Furthermore, the step (f) may include the steps of (f-1) receiving one or more selected from a coupon and membership points applied to the commodity whose purchase information has been obtained and (f-2) receiving a delivery address to which the commodity whose purchase information has been obtained is to be delivered.

Furthermore, the device may be any one of a smart watch, smart glasses, and a smart band.

In accordance with a second embodiment of the present invention, a server may include a purchase information storage unit configured to store information about one or more of the name, price, selling place, purchase quantity, applied coupon, and applied membership points of a commodity for one or more commodities, a commodity selection unit configured to receive commodity information from a device and to select a commodity included in the commodity information from the purchase information storage unit, a shopping basket generation unit configured to generate a shopping basket corresponding to each user with respect to the commodity selected by the commodity selection unit, and a commodity payment unit configured to receive a payment request from a device and to perform payment for the commodity included in the shopping basket generated by the shopping basket generation unit.

Furthermore, the commodity payment unit may perform payment for the commodity to be paid using the information about one or more stored in the purchase information storage unit.

### BRIEF DESCRIPTION OF THE DRAWINGS

FIG. 1 is a diagram showing major elements of a device.

FIG. 2 is a flowchart illustrating a method for paying a commodity using a device according to a first embodiment of the present invention.

FIG. 3 is a diagram showing the state in which a smart watch recognizes barcode attached to the package paper of a commodity.

FIG. 4 is a diagram showing the state in which commodity information is displayed on the display unit of a smart watch.

FIG. 5 is a diagram showing the state in which a user who has worn a smart watch performs a first gesture.

FIG. 6 is a diagram showing the state of a shopping basket to which a commodity displayed on the display unit of a smart watch has been added.

FIG. 7 is a diagram showing the state in which purchase information is displayed on the display unit of a smart watch.

FIG. 8 is a flowchart illustrating a method for paying a commodity using a device according to a second embodiment of the present invention.

FIG. 9 is a diagram showing the state of a shopping basket from which a commodity has been deleted from the shopping basket shown in FIG. 6.

FIG. 10 is a flowchart illustrating a method for paying a commodity using a device according to a third embodiment of the present invention.

FIG. 11 is a diagram showing the configuration of a server according to a fourth embodiment of the present invention.

### DETAILED DESCRIPTION

Hereinafter, some embodiments of the present invention are described in detail with reference to the exemplary drawings. The embodiments are provided so that those skilled in the art may easily understand the technical spirit of the present invention, and the present invention is not restricted by the embodiments. A detailed description of the known functions and constructions will be omitted if it is deemed to make the gist of the present invention unnecessarily vague.

Furthermore, contents represented in the accompanying drawings have been diagrammed in order to easily describe the embodiments of the present invention, and the contents may be different from forms that are actually implemented. It is to be noted that in assigning reference numerals to elements in the drawings, the same reference numerals denote the same elements throughout the drawings even in cases where the elements are shown in different drawings.

Furthermore, it should be understood that an expression that some elements are “included” is an expression of an “open type” and the expression simply denotes that the corresponding elements are present, but does not exclude additional elements.

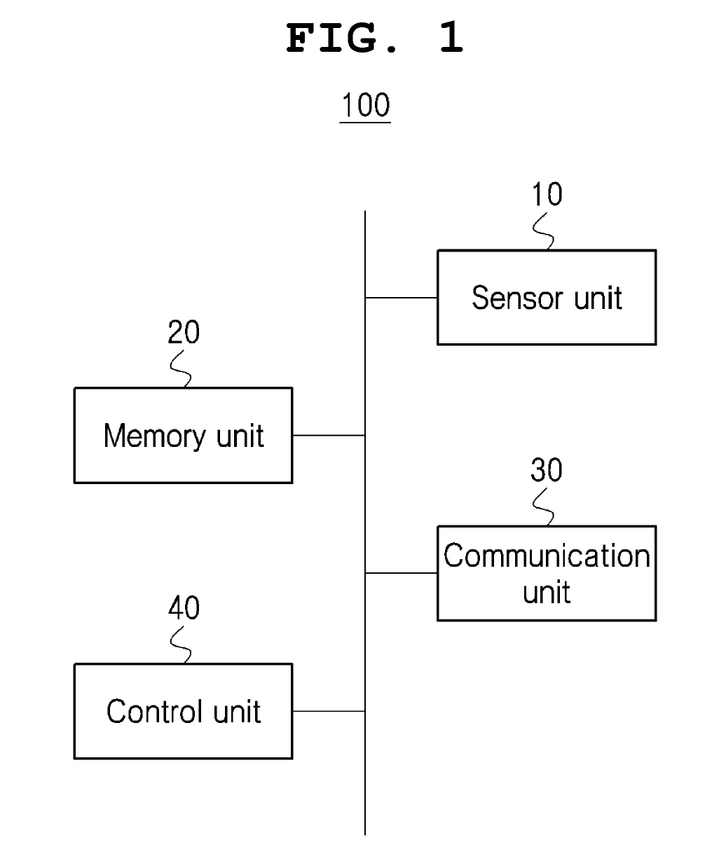

Prior to a description of a method for paying a commodity using a device according to a first embodiment of the present invention, the elements of a device 100 for performing steps according to another embodiment of the present invention are described in brief with reference to FIG. 1.

FIG. 1 is a diagram showing major elements of the device 100. The device 100 includes a sensor unit 10, a memory unit 20, a communication unit 30, and a control unit 40. The major elements of the device 100 correspond to only one embodiment, and some of the elements may be omitted or some additional elements may be added to the elements, if necessary.

The sensor unit 10 is mounted on the device 100 and measures various types of information about a user. In this case, the type of a sensor included in the sensor unit 10 is not limited, and the type of measured information is also not limited. For example, the sensor unit 10 may include one or more of an action recognition sensor, a camera sensor, an infrared sensor, a GPS sensor, a gyro sensor, a displacement sensor, a pressure sensor, a torque sensor, a proximity sensor, a gravity sensor, an image sensor, a sweat sensor, and other known sensors. Since information that may be measured by each of sensors is predetermined, the sensor unit 10 of the device 100 for recognizing a user's gesture may include one or more of an action recognition sensor, a displacement sensor, and a proximity sensor capable of recognizing a gesture.

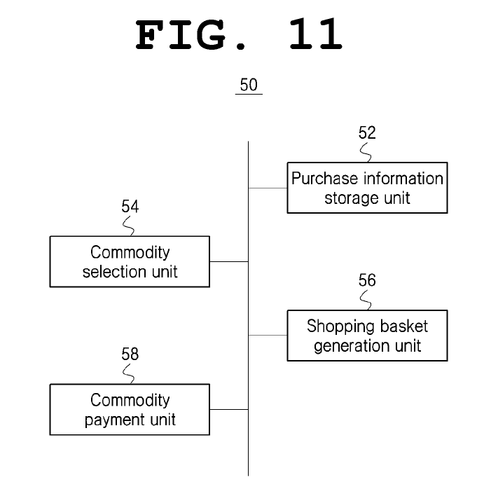

Furthermore, the sensor unit 10 recognizes a gesture of a user, compares the recognized gesture with a gesture previously set by the user and stored in the memory unit 20, and finally selects a gesture. Information about a commodity is transmitted to a server 50 (refer to FIG. 11) in response to the selected gesture.

The sensor unit 10 may also include a camera sensor. The camera sensor obtains commodity information by recognizing the barcode of the commodity. In this case, what the camera sensor obtains the commodity information is the first step in performing the method for paying a commodity using a device according to the first embodiment of the present invention. The commodity information is described in detail later.

The memory unit 20 stores a gesture indicative of an expression of a user's intentions. More specifically, a first gesture of putting a commodity in a shopping basket, a second gesture of deleting a commodity put in the shopping basket, etc. may have been previously set and stored in the memory unit 20. A gesture may be added and stored as many as a user likes in response to a user' setting. For example, a third gesture of paying a commodity put in a shopping basket, a fourth gesture of cancelling settlement, etc. may also be added and stored in the memory unit 20.

The memory unit 20 may include known storage media. For example, one or more of known storage media, such as ROM, PROM, EPROM, EEPROM, and RAM, may be used as the memory unit 20. However, the memory unit 20 of the device 100 needs to continue to store new information measured by the sensor unit 10. In this case, storage media capable of the input and deletion of information may be used as the memory unit 20 because existing information needs to be deleted depending on the capacity of the memory unit 20.

The communication unit 30 sends commodity information, obtained by the sensor unit 10, to the server 50 in response to a gesture stored in the memory unit 20 and receives purchase information from the server 50. Furthermore, when the server 50 adds a commodity to a shopping basket based on the received commodity information, the communication unit 30 may receive information about the added commodity. That is, the communication unit 30 functions to send and receive information between the device 100 and the server 50. Any of known communication methods, such as CDMA, WCDMA, GSM, 3G, and 4G, may be used by the communication unit 30. Accordingly, the communication unit may use communication means mounted on a mobile communication terminal, such as a smart phone.

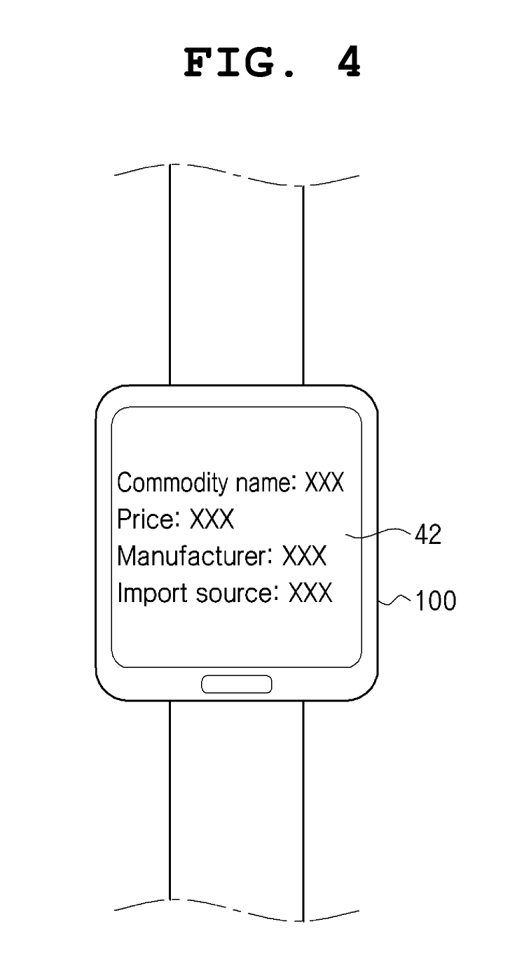

The control unit 40 displays purchase information, received from the server 50 through the communication unit 30, and information about a shopping basket on any one of a display unit 42 (refer to FIGS. 4, 6, 7, and 9) and a speaker unit 43. Accordingly, the control unit 40 may control the driving of the display unit 42 and the speaker unit 43, and may also control the driving of the sensor unit 10, the memory unit 20, and the communication unit 30. That is, the control unit 40 may be considered to be a kind of central processing unit (CPU) for controlling the overall driving of the device 100.

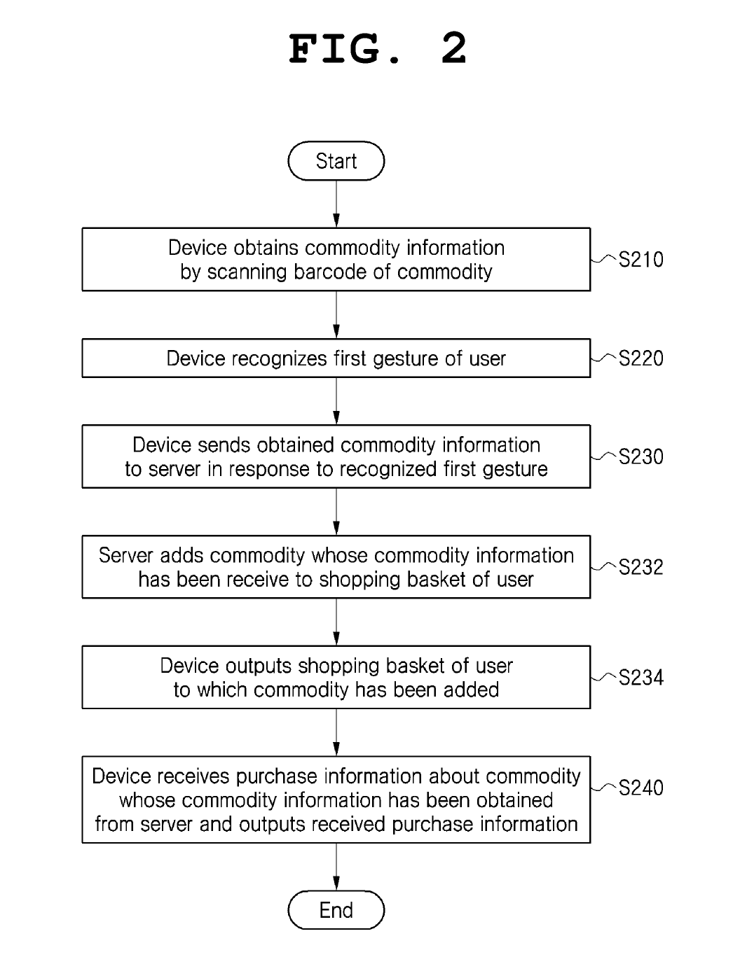

The method for paying a commodity using a device according to the first embodiment of the present invention may be described more effectively in connection with the sensor unit 10, the memory unit 20, the communication unit 30, and the control unit 40. The method is described below with reference to FIG. 2.

FIG. 2 is a flowchart illustrating the method for paying a commodity using the device according to the first embodiment of the present invention.

The embodiment of FIG. 2 is only one embodiment including exemplary steps in achieving an object of the present invention. Some of the steps may be modified or omitted or some steps may be added to the steps.

First, the device 100 obtains commodity information by scanning the barcode of a commodity at step S210. In this case, the device 100 may be a wearable device. More specifically, the device 100 may be any one of a smart watch, smart glasses, and a smart band. It is herein assumed that the device 100 is a smart watch.

A user visits a store in which commodities are sold and scans the barcode of a commodity using the sensor unit 10 of the smart watch, more specifically, a camera sensor. In this case, the store includes all of stores in which an article of food is sold, such as a department store, a convenience store, and a supermarket. The store may include any place in which commodities whose barcode can be scanned are sold although food is not sold. Furthermore, the barcode includes both two-dimensional barcode and three-dimensional barcode, and may include all of media including information about commodities, such as QR code, regardless of the type of media.

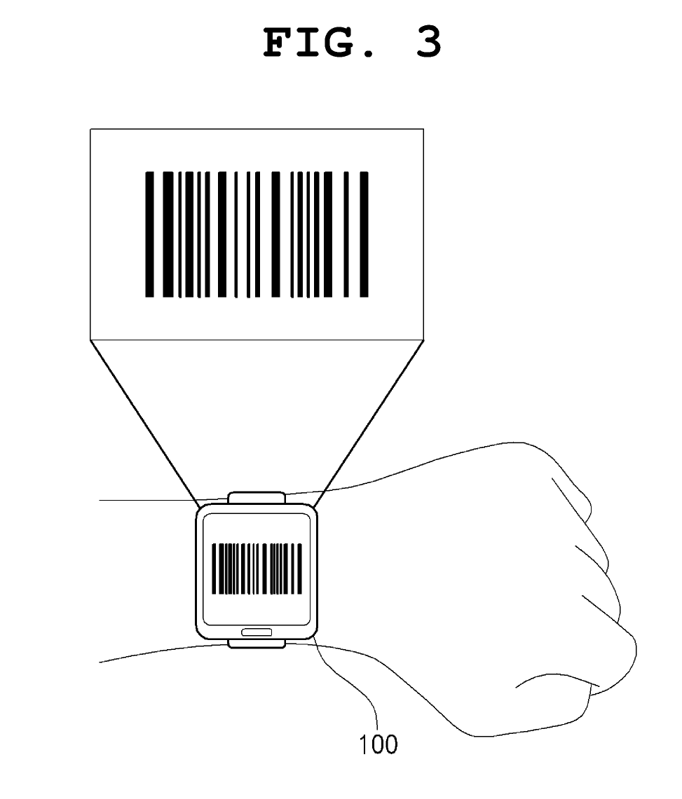

The scanning of barcode may be implemented as the basic function of the camera sensor. If the method for paying a commodity using the device according to the first embodiment of the present invention has been implemented using an application, however, barcode may be scanned after an application is driven. The reason for this is that in the camera sensor of the smart watch, to determine whether barcode that may be scanned is present in each captured photo or moving image is not preferred in terms of power consumption and a processor driving speed because the scanning of barcode is not a main function, but the capturing of a photo and a moving image is a main function. Accordingly, in order to implement an embodiment of the present invention, the camera sensor may be designed to be automatically driven as soon as an application is driven. In this case, the camera sensor that is automatically driven may place emphasis on the scanning of barcode. FIG. 3 shows the state in which the smart watch recognizes barcode attached to the package paper of a commodity.

The commodity information obtained through the barcode includes overall information about a commodity. Recently, commodity information is not complicatedly marked on the package paper of a commodity, but is provided to a consumer through a medium, such as barcode. Accordingly, commodity information may include all of types of information marked on the existing package of a commodity. For example, commodity information may include a commodity name, a commodity price, a manufacturer, manufacturer contact information, an import source, and import source contact information. If a commodity is food, commodity information may further include an expiration date, raw materials, and nutritional contents. The obtained commodity information may be displayed on the display unit 42 of the smart watch and may be separately stored in the memory unit 20. From FIG. 4, it may be seen that commodity information has been displayed on the display unit 42 of the smart watch.

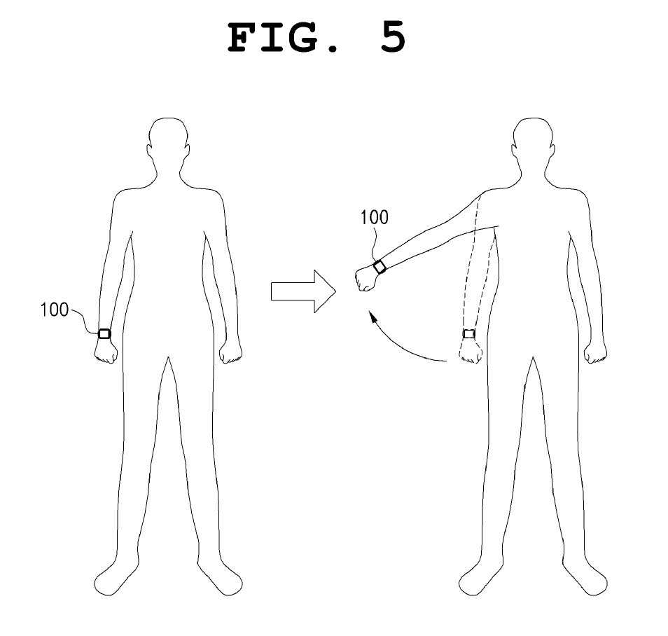

When the commodity information is obtained, the device 100 recognizes a first gesture of a user at step S220. In this case, the first gesture is a gesture indicative of an expression of purchase intentions of the user who wants to put the commodity whose commodity information has been obtained by scanning the barcode at step S210 in a shopping basket. The first gesture has been previously set and stored in the memory unit 20 of the device 100. Furthermore, the first gesture has only to indicate an expression of a user's intentions of putting a commodity in a shopping basket. Accordingly, various gestures may be set as the first gesture depending on a user choice. For example, as shown in FIG. 5, if a user has set a gesture of throwing his or her arm on which the smart watch has been worn to the right as a first gesture, when the user makes the first gesture, it is interpreted as an expression of purchase intentions of the user for a commodity whose commodity information has been obtained by scanning the barcode of the commodity. For another example, if a user has set a gesture of lowering his or her arm on which the smart watch has been worn downward as a first gesture, when the user makes the first gesture, it is interpreted as an expression of purchase intentions of the user for a commodity whose commodity information has been obtained by scanning the barcode of the commodity. The first gesture may be recognized through any one of the action recognition sensor, the displacement sensor, and the proximity sensor mounted on the device 100.

When the first gesture is recognized, the device 100 sends the obtained commodity information to the server 50 in response to the recognized first gesture at step S230. At step S220, the first gesture has been illustrated as being interpreted as an expression of purchase intentions of the user for the commodity whose commodity information has been obtained. Accordingly, the commodity information is transmitted to the server 50 through the recognition of the first gesture. The transmitted commodity information includes the commodity information, recognized at step S210, without any change, and may include a commodity name, a commodity price, a manufacturer, manufacturer contact information, an import source, and import source contact information. If the commodity is food, the transmitted commodity information may further include an expiration date, raw materials, and nutritional contents.

After the commodity information is transmitted to the server 50, the server 50 adds the commodity whose commodity information has been receive to a shopping basket of the user at step S232. In this case, the shopping basket means a storage space independently generated for each user within the server 50. A single user may have a plurality of shopping baskets, and a plurality of users may share a single shopping basket. For example, a single user may have a plurality of independent shopping baskets depending on the type of commodities, such as food and clothes. Users who have family relations, such as parents and sons and daughters, may share a single shopping basket. If the method for paying a commodity using the device according to the first embodiment of the present invention has been implemented using an application, the shopping basket may be generated when the application is downloaded onto the device 100 and a specific member registration procedure is performed. If the method is not implemented using an application, but has been implemented as a function of the device 100 itself, the shopping basket may be autonomously generated through the creation of an account of the device 100.

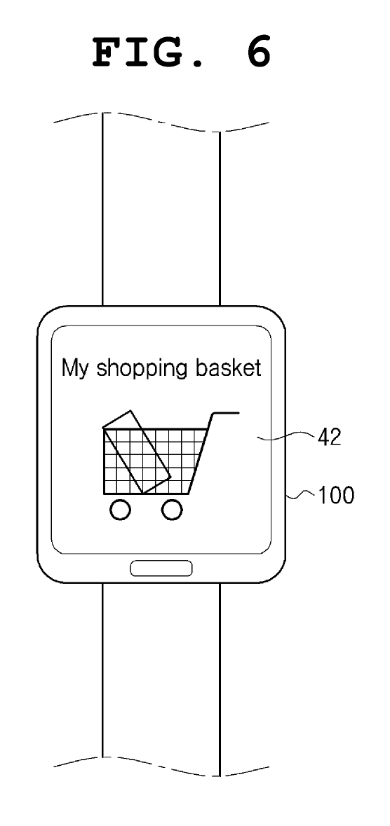

After the server 50 added the commodity whose commodity information has been obtained to the shopping basket of the user, the server 50 sends information about the added commodity to the device 100. The device 100 outputs the shopping basket of the user at step S234. FIG. 6 shows the state of a shopping basket to which the commodity has been added through the display unit 42 of the device 100, but this is only one embodiment. Such an addition may be output through a user interface (UI) implemented in various graphics. Furthermore, information about the commodity added to the shopping basket may be output at the same time when the shopping basket is output.

If the method for paying a commodity using the device according to the first embodiment of the present invention has been implemented using an application, the shopping basket of the user may be displayed on a driving screen of the application. If the method is not implemented using an application, but has been implemented as a function of the device 100 itself, the shopping basket of the user may be output in the form of a text message. In this case, the information, transmitted from the server 50 which has added the commodity whose commodity information has been obtained to the shopping basket of the user to the device 100, may be included in the text message.

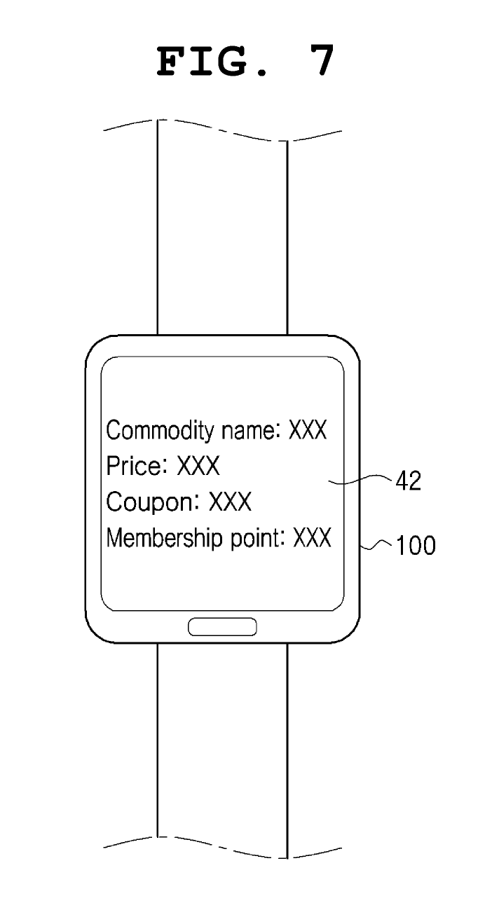

When the shopping basket to which the commodity has been added is output to the device 100, the device 100 receives purchase information about the commodity whose commodity information has been obtained from the server 50 and outputs the received purchase information at step S240. In this case, the purchase information means information which is helpful to the user when the user purchases the commodity whose commodity information has been obtained, and may include information about one or more of the name, price, selling place, purchase quantity, applied coupon, and applied membership points of the commodity. Purchase information has been previously stored in the server 50 for each commodity. In this case, the applied membership points may include both points provided by each communication service company and a loyalty stamp (or coupon) provided at a specific selling place. Furthermore, the purchase information includes information about a credit card. For example, the purchase information may include information about a credit card which provides a discount service or which enables settlement through points provided by the credit card. FIG. 7 shows the state in which the purchase information has been displayed on the display unit 42 of the device 100.

The method for paying a commodity using the device according to the first embodiment of the present invention illustrates the steps for selecting, by a user, a commodity, scanning commodity information, adding the commodity to a shopping basket, and outputting purchase information. Accordingly, a user can pay a commodity, added to a shopping basket, using purchase information. However, a commodity added to a shopping basket may not be paid due to a factor, such as a user's decision or change of mind or a reduction of a purchase need. In this case, there is a need for a step for deleting the commodity added to the shopping basket. A method for paying a commodity using the device according to a second embodiment of the present invention is described below.

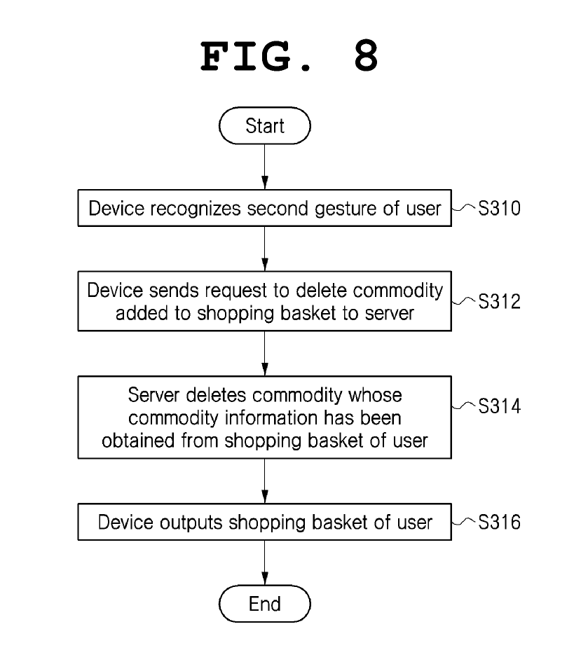

FIG. 8 is a flowchart illustrating the method for paying a commodity using the device according to the second embodiment of the present invention.

The embodiment of FIG. 8 is only one embodiment including exemplary steps in achieving an object of the present invention. Some of the steps may be modified or omitted or some steps may be added to the steps.

The method for paying a commodity using the device according to the second embodiment of the present invention starts from step S240, that is, the last step of the method for paying a commodity using the device according to the first embodiment. That is, the commodity has been added to the shopping basket.

First, the device 100 recognizes a second gesture of the user at step S310. In this case, the second gesture is a gesture indicative of an expression of purchase cancel of the user who wants to delete the commodity, added to the shopping basket, from the shopping basket. The second gesture has been previously set and stored in the memory unit 20 of the device 100. Furthermore, the second gesture has only to indicate an expression of a user's intentions of deleting the commodity from the shopping basket. Various gestures may be set as the second gesture depending on a user choice. For example, if a user has set a gesture of throwing his or her arm on which the smart watch has been worn to the right as a first gesture, the user may set a gesture of throwing his or her arm on which the smart watch has been worn to the left as a second gesture. For another example, if a user has set a gesture of lowering his or her arm on which the smart watch has been worn downward as a first gesture, the user may set a gesture of raising up his or her arm on which the smart watch has been worn as a second gesture. Such a second gesture is only one embodiment. The second gesture does not need to be opposite the first gesture and has only to be different from the first gesture. In the embodiment, when the user throws his or her arm on which the smart watch has been worn to the left, it is interpreted as an expression of purchase cancel of the user who wants to delete the commodity added to the shopping basket. When the user raises up his or her arm on which the smart watch has been worn, it is interpreted as an expression of purchase cancel of the user who wants to delete the commodity added to the shopping basket. Like the first gesture, the second gesture may also be recognized through any one of the action recognition sensor, the displacement sensor, and the proximity sensor mounted on the device 100.

The commodity added to the shopping basket may be deleted from the shopping basket in response to the second gesture of the user, but a case where the commodity deleted from the shopping basket is added to the shopping basket again may be generated. In this case, the corresponding commodity may be scanned and added to the shopping basket in response to the first gesture, but this may be very inconvenient. Accordingly, a third gesture indicative of an expression of a user's intentions of adding the commodity, deleted from the shopping basket, to the shopping basket again may be set in order to easily add the commodity, deleted from the shopping basket, to the shopping basket again. For example, if a user has set a gesture of throwing his or her arm on which the smart watch has been worn to the right as a first gesture and has set a gesture of throwing his or her arm on which the smart watch has been worn to the left as a second gesture, the user may set a gesture of holding out his or her arm on which the smart watch has been worn forward as a third gesture. For another example, if a user has set a gesture of lowering his or her arm on which the smart watch has been worn downward as a first gesture and has set a gesture of raising up his or her arm on which the smart watch has been worn as a second gesture, the user may set a gesture of reaching out his or her arm on which the smart watch has been worn diagonally as a third gesture. Such a third gesture is only one embodiment. The third gesture does not need to be opposite the first and the second gestures and has only to be different from the first and the second gestures.

In the embodiment, when the user holds out his or her arm on which the smart watch has been worn forward, it is interpreted as an expression of a user's intentions of adding the commodity, deleted from the shopping basket, to the shopping basket again. When the user reaches out his or her arm on which the smart watch has been worn diagonally, it is interpreted as an expression of a user's intentions of adding the commodity, deleted from the shopping basket, to the shopping basket again. Like the first and the second gestures, the third gesture may also be recognized through any one of the action recognition sensor, the displacement sensor, and the proximity sensor mounted on the device 100.

The device 100 that has recognized the second gesture sends a commodity deletion request to the server 50 at step S312. In response to the request, the server 50 deletes the commodity whose commodity information has been obtained from the shopping basket of the user at step S314. In this case, the shopping basket means a storage space independently generated for each user within the server 50. A single user may have a plurality of shopping baskets, and a plurality of users may share a single shopping basket. For example, a single user may have a plurality of independent shopping baskets depending on the type of commodities, such as food and clothes. Users who have family relations, such as parents and sons and daughters, may share a single shopping basket. If the method for paying a commodity using the device according to the second embodiment of the present invention has been implemented using an application, the shopping basket may be generated when the application is downloaded onto the device 100 and a specific member registration procedure is performed. If the method is not implemented using an application, but has been implemented as a function of the device 100 itself, the shopping basket may be autonomously generated through the creation of an account of the device 100.

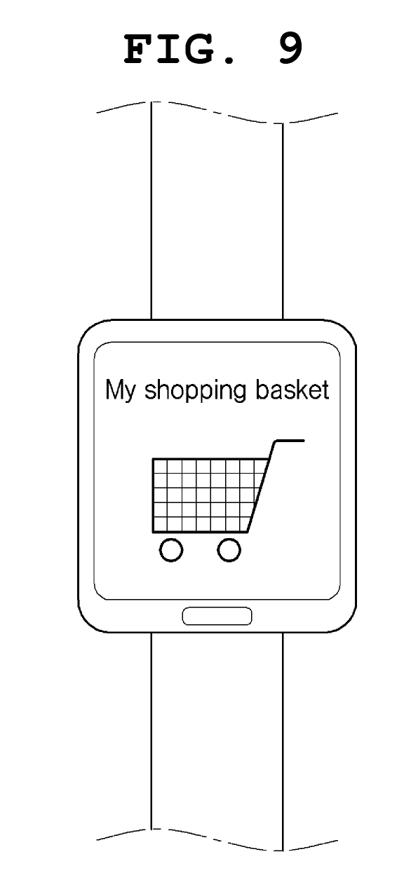

After the server 50 deletes the commodity whose commodity information has been obtained from the shopping basket of the user, the server 50 sends information about the deletion to the device 100. The device 100 outputs the shopping basket of the user at step S316. FIG. 9 shows the state of a shopping basket from which the commodity added to the shopping basket of FIG. 6 has been deleted, but this is only one embodiment. As in the case where the commodity is added to the shopping basket, such deletion may be output through a user interface (UI) implemented in various graphics. Furthermore, information about the commodity deleted from the shopping basket may be output at the same time when the shopping basket is output.

If the method for paying a commodity using the device according to the second embodiment of the present invention has been implemented using an application, the shopping basket of the user may be displayed on a driving screen of the application. If the method is not implemented using an application, but has been implemented as a function of the device 100 itself, the shopping basket of the user may be output in the form of a text message. In this case, the information, transmitted from the server 50 which has deleted the commodity whose commodity information has been obtained from the shopping basket of the user to the device 100, may be included in the text message.

In accordance with the method for paying a commodity using the device according to the second embodiment of the present invention, a user can easily delete a commodity, added to a shopping basket, from the shopping basket. Furthermore, a user can easily add a commodity, deleted from a shopping basket, to the shopping basket again by making the third gesture without making the first gesture.

Furthermore, in accordance with the methods for paying a commodity using the device according to the first and the second embodiments of the present invention, a user does not need to put commodities in a basket or cart one by one in the place where the commodities may be purchased, such as a department store, a convenience store, or a supermarket. Furthermore, a user can easily pay a commodity added to a shopping basket without a need to wait for his or her payment order at the checkout counter for a long time. A method for paying a commodity using the device according to a third embodiment of the present invention is described below.

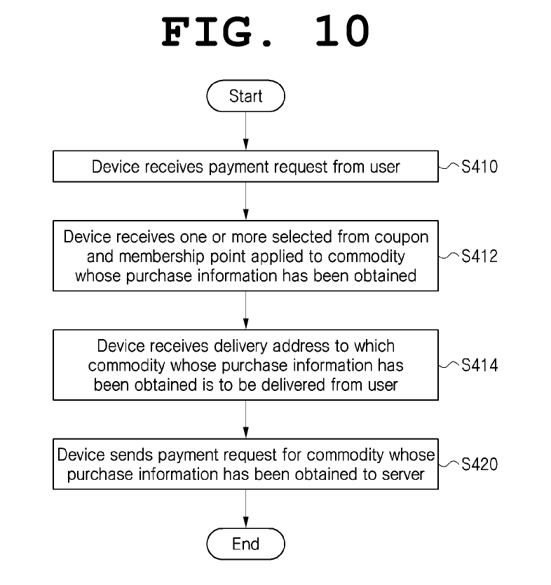

FIG. 10 is a flowchart illustrating the method for paying a commodity using the device according to the third embodiment of the present invention.

The embodiment of FIG. 10 is only one embodiment including exemplary steps in achieving an object of the present invention. Some of the steps may be modified or omitted or some steps may be added to the steps.

The method for paying a commodity using the device according to the third embodiment of the present invention starts from step S240, that is, the last step of the method for paying a commodity using the device according to the first embodiment, or step S314, that is, the last step of the method for paying a commodity using the device according to the second embodiment. That is, the commodity has been added to the shopping basket.

Although a shopping basket to which a commodity has been added is displayed on the display unit 42 of the device 100, payment for the commodity may not be forcedly performed against a user's intentions. Accordingly, for the payment, a specific payment request needs to be inputted by a user.

First, the device 100 receives a payment request from the user at step S410. In this case, the payment request includes a purchase intention of the user for the commodity whose purchase information has been obtained. When the payment request is inputted, it may be considered to be a purchase intention of the user. For example, the card number, available period, and password of a credit card by which payment is to be performed may be received.

If the method for paying a commodity using the device according to the third embodiment of the present invention has been implemented using an application, a separate menu or a pop-up window for performing payment may be generated. A purchase intention may be checked by selecting a corresponding menu or pop-up window.

Furthermore, step S410 may further include step S412 in which the device 100 receives one or more selected from a coupon and membership points applied to the commodity whose purchase information has been obtained. The purchase information transmitted by the server 50 includes various types of information helpful to the purchase of a user. One or more of a discount, a coupon capable of loyalty points, and applied membership points for a settlement cost for the commodity may be selected. Accordingly, a company which provides a coupon or an applied membership points can have a kind of marketing effect.

After step S412, the device 100 may further receive a delivery address to which the commodity whose purchase information has been obtained is to be delivered at step S414. In this case, if delivery information is received, it corresponds to only a case where the commodity is not directly picked up. Accordingly, step S414 is not essential. The inputted delivery address is transmitted to the server 50 along with a payment request at step S420 to be described later.

The payment request may be differently inputted depending on the type of device 100. For example, if the device 100 is a handheld phone, the payment request may be inputted through a keypad. If the device 100 is a smart watch, the payment request may be inputted through the display unit 42 because the display unit 42 is commonly a touch screen. In the case of other devices, the payment request may be inputted through input means included in a corresponding device.

When the payment request is received from the user, the device 100 sends the payment request for the commodity whose purchase information has been obtained to the server 50 at step S420. That is, the device 100 receives only settlement information from the user, and actual payment is performed in the server 50. Accordingly, the server 50 may include an electronic payment system capable of performing payment for a commodity added to a shopping basket which has been generated for each user. In some embodiments, a separate server capable of performing payment only, which is different from the server 50 for a shopping basket, may be provided and may perform payment through association between the servers.

When one or more of the applied coupon or applied membership points and the delivery address are received at steps S412 and S414, they are transmitted to the server 50 along with the payment request. Accordingly, the server 50 may need to have information about coupons or membership points applied to the commodity including the purchase information, and may be equipped with a system for associating the coupons or membership points with payment, but this is only one embodiment. A separate server which has information about coupons or membership points applied to a commodity and associates the coupons or membership points with payment may be provided. Payment for a commodity may be performed through association between the server 50 and the separate server. The same is true of the case where a delivery address has been received. The server 50 may have only to manage the delivery address and may operate in conjunction with the server of a courier company, thereby being capable of improving user convenience.

In accordance with the method for paying a commodity using the device according to the third embodiment of the present invention, a user can pay a commodity added to a shopping basket rapidly and easily through the device 100 without paying the commodity at the checkout counter, and can have a discount or loyalty points by selecting a coupon or membership points applied to a commodity. Accordingly, a user can receive a substantial help in purchasing a commodity and does not need to carry a purchased commodity home by inputting a delivery address.

The methods for paying a commodity, which may be performed if the device 100 is a smart watch, have been described so far. Methods for paying a commodity, which may be performed if the device 100 is smart glasses, are described below.

First, the device 100 obtains commodity information by scanning the barcode of a commodity at step S210′. A user visits a store in which commodities are sold and scans the barcode of a commodity using the sensor unit 10 of the smart glasses, more specifically, a camera sensor. In this case, the store includes all of stores in which an article of food is sold, such as a department store, a convenience store, and a supermarket. The store may include any place in which commodities whose barcode can be scanned are sold although food is not sold. Furthermore, the barcode includes both two-dimensional barcode and three-dimensional barcode, and may include all of media including information about commodities, such as QR code, regardless of the type of media.

The scanning of barcode may be implemented as the basic function of the camera sensor. If the method for paying a commodity using the device according to the first embodiment of the present invention has been implemented using an application, however, barcode may be scanned after an application is driven. The reason for this is that in the camera sensor of a smart watch, to determine whether barcode that may be scanned is present in each captured photo or moving image is not preferred in terms of power consumption and a processor driving speed because the scanning of barcode is not a main function, but the capturing of a photo and a moving image is a main function. Accordingly, in order to implement an embodiment of the present invention, the camera sensor may be designed to be automatically driven as soon as an application is driven. In this case, the camera sensor that is automatically driven may place emphasis on the scanning of barcode.

The commodity information obtained through the barcode includes overall information about a commodity. Recently, commodity information is not complicatedly marked on the package paper of a commodity, but is provided to a consumer through a medium, such as barcode. Accordingly, commodity information may include all of types of information marked on the existing package of a commodity. For example, commodity information may include a commodity name, a commodity price, a manufacturer, manufacturer contact information, an import source, and import source contact information. If a commodity is food, commodity information may further include an expiration date, raw materials, and nutritional contents. The obtained commodity information may be displayed on the display unit 42 of the smart glasses and may be separately stored in the memory unit 20.

When the commodity information is obtained, the device 100 recognizes a first gesture of a user at step S220′. In this case, the first gesture is a gesture indicative of an expression of purchase intentions of the user who wants to put the commodity whose commodity information has been obtained by scanning the barcode at step S210′ in a shopping basket. The first gesture has been previously set and stored in the memory unit 20 of the device 100. Furthermore, the first gesture has only to indicate an expression of a user's intentions of putting a commodity in a shopping basket. Accordingly, various gestures may be set as the first gesture depending on a user choice. For example, if a user has set a gesture of throwing his or her arm to the right as a first gesture, when the user makes the first gesture in the state in which the user has worn the smart glasses, it is interpreted as an expression of purchase intentions of the user for a commodity whose commodity information has been obtained by scanning the barcode of the commodity. For another example, if a user has set a gesture of lowering his or her arm downward as a first gesture, when the user makes the first gesture in the state in which the user has worn the smart glasses, it is interpreted as an expression of purchase intentions of the user for a commodity whose commodity information has been obtained by scanning the barcode of the commodity. The first gesture may be recognized through any one of the action recognition sensor, the displacement sensor, and the proximity sensor mounted on the device 100. However, unlike in a smart watch, in the smart glasses, the first gesture may be recognized through a camera sensor. The reason for this is that a gesture is performed through a hand action of the smart glasses.

When the first gesture is recognized, the device 100 sends the obtained commodity information to the server 50 in response to the recognized first gesture at step S230′. At step S220′, the first gesture has been illustrated as being interpreted as an expression of purchase intentions of the user for the commodity whose commodity information has been obtained. Accordingly, the commodity information is transmitted to the server 50 through the recognition of the first gesture. The transmitted commodity information includes the commodity information, recognized at step S210′, without any change, and may include a commodity name, a commodity price, a manufacturer, manufacturer contact information, an import source, and import source contact information. If the commodity is food, the transmitted commodity information may further include an expiration date, raw materials, and nutritional contents.

After the commodity information is transmitted to the server 50, the server 50 adds the commodity whose commodity information has been receive to a shopping basket of the user at step S232′. In this case, the shopping basket means a storage space independently generated for each user within the server 50. A single user may have a plurality of shopping baskets, and a plurality of users may share a single shopping basket. For example, a single user may have a plurality of independent shopping baskets depending on the type of commodities, such as food and clothes. Users who have family relations, such as parents and sons and daughters, may share a single shopping basket. If the method for paying a commodity using the device according to the first embodiment of the present invention has been implemented using an application, the shopping basket may be generated when the application is downloaded onto the device 100 and a specific member registration procedure is performed. If the method is not implemented using an application, but has been implemented as a function of the device 100 itself, the shopping basket may be autonomously generated through the creation of an account of the device 100.

After the server 50 added the commodity whose commodity information has been obtained to the shopping basket of the user, the server 50 sends information about the added commodity to the device 100. The device 100 outputs the shopping basket of the user at step S234′. The shape of a shopping basket to which the commodity has been added may be output through a user interface (UI) implemented in various graphics. Furthermore, information about the commodity added to the shopping basket may be output at the same time when the shopping basket is output.

If the method for paying a commodity using the device according to the first embodiment of the present invention has been implemented using an application, the shopping basket of the user may be displayed on a driving screen of the application. If the method is not implemented using an application, but has been implemented as a function of the device 100 itself, the shopping basket of the user may be output in the form of a text message. In this case, the information, transmitted from the server 50 which has added the commodity whose commodity information has been obtained to the shopping basket of the user to the device 100, may be included in the text message.

When the shopping basket to which the commodity has been added is output to the device 100, the device 100 receives purchase information about the commodity whose commodity information has been obtained from the server 50 and outputs the received purchase information at step S240′. In this case, the purchase information means information which is helpful to the user when the user purchases the commodity whose commodity information has been obtained, and may include information about one or more of the name, price, selling place, purchase quantity, applied coupon, and applied membership points of the commodity. Purchase information has been previously stored in the server 50 for each commodity. In this case, the applied membership points may include both points provided by each communication service company and a loyalty stamp (or coupon) provided at a specific selling place. Furthermore, the purchase information includes information about a credit card. For example, the purchase information may include information about a credit card which provides a discount service or which enables settlement through points provided by the credit card.

The method for paying a commodity using the device according to the second embodiment of the present invention may be performed if the device 100 is smart glasses. The method is described below.

First, the device 100 recognizes a second gesture of the user at step S310′. In this case, the second gesture is a gesture indicative of an expression of purchase cancel of the user who wants to delete the commodity, added to the shopping basket, from the shopping basket. The second gesture has been previously set and stored in the memory unit 20 of the device 100. Furthermore, the second gesture has only to indicate an expression of a user's intentions of deleting the commodity from the shopping basket. Various gestures may be set as the second gesture depending on a user choice. For example, if a user has set a gesture of throwing his or her arm to the right as a first gesture, the user may set a gesture of throwing his or her arm to the left as a second gesture. For another example, if a user has set a gesture of lowering his or her arm downward as a first gesture, the user may set a gesture of raising up his or her arm as a second gesture. Such a second gesture is only one embodiment. The second gesture does not need to be opposite the first gesture and has only to be different from the first gesture. In the embodiment, when the user throws his or her arm to the left, it is interpreted as an expression of purchase cancel of the user who wants to delete the commodity added to the shopping basket. When the user raises up his or her arm on which the smart glasses has been worn, it is interpreted as an expression of purchase cancel of the user who wants to delete the commodity added to the shopping basket. Like the first gesture, the second gesture may also be recognized through any one of the action recognition sensor, the displacement sensor, and the proximity sensor mounted on the device 100, but may be recognized through a camera sensor mounted on the smart glasses. The reason for this is that a gesture is performed through a hand action.

The commodity added to the shopping basket may be deleted from the shopping basket in response to the second gesture of the user, but a case where the commodity deleted from the shopping basket is added to the shopping basket again may be generated. In this case, the corresponding commodity may be scanned and added to the shopping basket in response to the first gesture, but this may be very inconvenient. Accordingly, a third gesture indicative of an expression of a user's intentions of adding the commodity, deleted from the shopping basket, to the shopping basket again may be set in order to easily add the commodity, deleted from the shopping basket, to the shopping basket again. For example, if a user has set a gesture of throwing his or her arm to the right as a first gesture and has set a gesture of throwing his or her arm to the left as a second gesture, the user may set a gesture of holding out his or her arm forward as a third gesture. For another example, if a user has set a gesture of lowering his or her arm downward as a first gesture and has set a gesture of raising up his or her arm as a second gesture, the user may set a gesture of reaching out his or her arm diagonally as a third gesture. Such a third gesture is only one embodiment. The third gesture does not need to be opposite the first and the second gestures and has only to be different from the first and the second gestures.

In the embodiment, when the user holds out his or her arm forward, if such an action is recognized through the smart glasses, it is interpreted as an expression of a user's intentions of adding the commodity, deleted from the shopping basket, to the shopping basket again. When the user reaches out his or her arm diagonally, if such an action is recognized through the smart glasses, it is interpreted as an expression of a user's intentions of adding the commodity, deleted from the shopping basket, to the shopping basket again. Like the first and the second gestures, the third gesture may also be recognized through any one of the action recognition sensor, the displacement sensor, and the proximity sensor mounted on the device 100, but may be recognized through a camera sensor mounted on the smart glasses. The reason for this is that a gesture is performed through a hand action.

The device 100 that has recognized the third gesture sends a commodity deletion request to the server 50. In response to the request, the server 50 deletes the commodity whose commodity information has been obtained from the shopping basket of the user at step S312′. In this case, the shopping basket means a storage space independently generated for each user within the server 50. A single user may have a plurality of shopping baskets, and a plurality of users may share a single shopping basket. For example, a single user may have a plurality of independent shopping baskets depending on the type of commodities, such as food and clothes. Users who have family relations, such as parents and sons and daughters, may share a single shopping basket. If the method for paying a commodity using the device according to the second embodiment of the present invention has been implemented using an application, the shopping basket may be generated when the application is downloaded onto the device 100 and a specific member registration procedure is performed. If the method is not implemented using an application, but has been implemented as a function of the device 100 itself, the shopping basket may be autonomously generated through the creation of an account of the device 100.

After the server 50 deletes the commodity whose commodity information has been obtained from the shopping basket of the user, the server 50 sends information about the deletion to the device 100. The device 100 outputs the shopping basket of the user at step S314′. The commodity deleted from the shopping basket may be output through a user interface (UI) implemented in various graphics, as in the case where a commodity is added to a shopping basket. Furthermore, information about the commodity deleted from the shopping basket may be output at the same time when the shopping basket is output.

If the method for paying a commodity using the device according to the second embodiment of the present invention has been implemented using an application, the shopping basket of the user may be displayed on a driving screen of the application. If the method is not implemented using an application, but has been implemented as a function of the device 100 itself, the shopping basket of the user may be output in the form of a text message. In this case, the information, transmitted from the server 50 which has deleted the commodity whose commodity information has been obtained from the shopping basket of the user to the device 100, may be included in the text message.

Payment for a commodity may be performed through the device 100 if the device 100 is smart glasses. This is described below.

First, the device 100 receives a payment request from the user at step S410′. In this case, the payment request includes a purchase intention of the user for the commodity whose purchase information has been obtained. When the payment request is inputted, it may be considered to be a purchase intention of the user. For example, the card number, available period, and password of a credit card by which payment is to be performed may be received. If the method for paying a commodity using the device according to the third embodiment of the present invention has been implemented using an application, a separate menu or a pop-up window for performing payment may be generated. A purchase intention may be checked by selecting a corresponding menu or pop-up window.

Furthermore, step S410′ may further include step S412′ in which the device 100 receives one or more selected from a coupon and membership points applied to the commodity whose purchase information has been obtained. The purchase information transmitted by the server 50 includes various types of information helpful to the purchase of a user. One or more of a discount, a coupon capable of loyalty points, and applied membership points for a settlement cost for the commodity may be selected. Accordingly, a company which provides a coupon or an applied membership points can have a kind of marketing effect.

After step S412′, the device 100 may further receive a delivery address to which the commodity whose purchase information has been obtained is to be delivered at step S414′. In this case, if delivery information is received, it corresponds to only a case where the commodity is not directly picked up. Accordingly, step S414′ is not essential. The inputted delivery address is transmitted to the server 50 along with a payment request at step S420′ to be described later.

The payment request may be differently inputted depending on the type of device 100. For example, if the device 100 is a handheld phone, the payment request may be inputted through a keypad. If the device 100 is a smart watch, the payment request may be inputted through the display unit 42 because the display unit 42 is commonly a touch screen. If the device 100 is smart glasses, the payment request may be inputted using input means, such as input through the direction of a line of sight or input by a touch. In the case of other devices, the payment request may be inputted through input means included in a corresponding device.

When the payment request is received from the user, the device 100 sends the payment request for the commodity whose purchase information has been obtained to the server 50 at step S420′. That is, the device 100 receives only settlement information from the user, and actual payment is performed in the server 50. Accordingly, the server 50 may include an electronic payment system capable of performing payment for a commodity added to a shopping basket which has been generated for each user. In some embodiments, a separate server capable of performing payment only, which is different from the server 50 for a shopping basket, may be provided and may perform payment through association between the servers.

When one or more of the applied coupon or applied membership points and the delivery address are received at steps S412′ and S414′, they are transmitted to the server 50 along with the payment request. Accordingly, the server 50 may need to have information about coupons or membership points applied to the commodity including the purchase information, and may be equipped with a system for associating the coupons or membership points with payment, but this is only one embodiment. A separate server which has information about coupons or membership points applied to a commodity and associates the coupons or membership points with payment may be provided. Payment for a commodity may be performed through association between the server 50 and the separate server. The same is true of the case where a delivery address has been received. The server 50 may have only to manage the delivery address and may operate in conjunction with the server of a courier company, thereby being capable of improving user convenience.

In the methods for paying a commodity using the device according to the first to third embodiments, regardless of the case where the device 100 is a smart watch or smart glasses, the server 50 which generates a shopping basket, has purchase information about a commodity, and performs actual payment has a very important meaning. Accordingly, the server 50 according to a fourth embodiment of the present invention is described below.

FIG. 11 is a diagram showing the configuration of the server 50 according to the fourth embodiment of the present invention. The server 50 includes a purchase information storage unit 52, a commodity selection unit 54, a shopping basket generation unit 56, and a commodity payment unit 58. However, the embodiment of FIG. 11 is only one embodiment including exemplary steps in achieving an object of the present invention. Some of the steps may be modified or omitted or some steps may be added to the steps, if necessary.

Information about one or more of the names, prices, selling places, purchase quantities, applied coupons, and applied membership points of commodities has been stored in the purchase information storage unit 52 by one or more commodities. In this case, purchase information is information transmitted to the device 100 when commodity information is received from the device 100 and a corresponding commodity is added to the shopping basket of a user. The purchase information may give a substantial help when a user purchases a commodity. Accordingly, the purchase information may be updated in real time because it may be changed at any time due to various causes. For example, if membership points applied to a commodity A are the membership points of a company B, the membership points of the company B may be no longer applied to the commodity A, and the membership points of a company C may be additionally applied to the commodity A. If purchase information is able to be updated, the problem of the above example can be solved without any problem.

The commodity selection unit 54 selects a commodity stored in the purchase information storage unit 52. In this case, the selected commodity is a commodity whose commodity information has been received from the device 100. For example, if commodity information about a commodity A has been received from the device 100, the commodity selection unit 54 may select the commodity A from the purchase information storage unit 52. Accordingly, the purchase information storage unit 52 and the commodity selection unit 54 have been associated with each other.

The shopping basket generation unit 56 generates a shopping basket for each user with respect to a commodity selected by the commodity selection unit 54. For example, if a user A has made a first gesture of adding commodities B and C to a shopping basket, the commodities B and C are added to a shopping basket of the user A, thereby generating the shopping basket. However, the shopping basket may not be generated for each user. For example, a plurality of shopping baskets for a single user may be generated, or a single shopping basket for a plurality of users may be generated.

The commodity payment unit 58 receives a payment request from the device 100, and performs payment for a commodity included in a shopping basket generated by the shopping basket generation unit 56. That is, the commodity payment unit 58 means an electronic payment system, and may perform payment for a commodity to be paid using one or more of pieces of information stored in the purchase information storage unit 52, more specifically, one or more of a coupon or membership points applied to the commodity.

If a user inputs a delivery address through the device 100, the server 50 according to the fourth embodiment of the present invention manages information about the delivery address and also provides information about the delivery of a commodity to the user while operating in conjunction with the server of a courier company, thereby being capable of promoting user convenience.

Those skilled in the art to which the present invention pertains will appreciate that the present invention may be implemented in other detailed forms without changing the technical spirit or essential characteristic of the present invention. Accordingly, it is to be understood that the aforementioned embodiments are only illustrative, but are not limiting or restrictive. Furthermore, the flowcharts shown in the drawings are merely sequential order illustrated to achieve the most preferred results in implementing the present invention, and other additional steps may be provided or some of the steps may be deleted.

Technological characteristics described in this specification and an implementation for executing the technological characteristics may be implemented using a digital electronic circuit, may be implemented using computer software, firmware or hardware including the structure described in this specification and structural equivalents thereof, or may be implemented using a combination of one or more of them. Furthermore, the implementation for executing the technological characteristics described in this specification may be implemented using a computer program product, that is, a module regarding computer program instructions encoded on a kind of program storage media in order to control the operation of a processing system or for execution by the processing system.

A computer-readable medium may be a machine-readable storage device, a machine-readable storage substrate, a memory device, a composition of materials that affect a machine-readable electromagnetic signal or a combination of one or more of them.

In this specification, the term “apparatus” covers all apparatuses, devices, and machines for processing data, for example, including a processor, a computer or a multi-processor, or a computer.

A computer program also known as a program, software, a software application, a script or code may be written in any form of a programming language which includes a compiled or interpreted language or a transcendental and/or procedural language, and may also be implemented in any form including an independent program or module, a component, a subroutine or other units suitable for being used in a computer environment. The computer program does not need to necessarily correspond to a file of a file system. The computer program may be stored in a single file provided to a requested program, multiple files that interact with each other (e.g., a file that stores one or more modules, a lower program or part of code), or another program or part of a file including data (e.g., one or more scripts stored in markup language document). The computer program may be placed in a single site or distributed to a plurality of sites and may be implemented to be executed on multiple computers or one or more computers interconnected over wired/wireless communication networks.

A computer-readable medium suitable for storing computer program instructions and data may include semiconductor memory devices, such as EPROM, EEPROM, and a flash memory device, for example, all types of non-volatile memory, media, and memory devices including magnetic disks, such as an internal hard disk or an external disk, magneto optical disks, CDs, and DVDs. The processor and the memory may be supplemented by a logic circuit for a special object or may be integrated into the logic circuit for a special object.

An implementation for executing the subject matter described in this specification may be implemented in an operation system including a backend component, such as a data server, a middleware component, such as an application server, a frontend component, such as a client computer having a web browser or graphic user interface capable of interacting with the implementation of the subject matter described by a user in this specification or all combinations of one or more of the backend, middleware, and frontend components. The component of the system may be accessed by any type or medium for digital data communication, such as a communication network.

Hereinafter, a more detailed embodiment capable of implementing the elements included in the method and server for paying a commodity using a device, described in this specification, along with the aforementioned contents is described in detail.

The method and server for paying a commodity using a device, which have been described in this specification, may be used partially or generally through a server related to a client device or web-based storage system or means for executing computer software, program code or instructions on one or more processors included in a server. In this case, the processor may be part of a server, a client, network infrastructure, or a computing platform, such as a mobile computing platform or fixed computing platform. More specifically, the processor may be a kind of computer or processing device capable of executing program instructions, code, etc. Furthermore, the processor may further include memory for storing the method, instructions, code or program for paying a commodity using a device. If memory is not included in the processor, the processor may access a storage device, such as CD-ROM, DVD, memory, a hard disk, a flash drive, RAM, ROM, or a cache in which the method, instructions, code or program for paying a commodity using a device has been stored, through a separate interface.

Furthermore, the method and server for paying a commodity using a device, which have been described in this specification, may be used partially or generally through an apparatus for executing computer software on a server, a client, a gateway, a hub, a router or network hardware. In this case, the software may be executed in various types of servers, such as a file server, a print server, a domain server, an Internet server, an intranet server, a host server, and a distributed server. The aforementioned servers may further include memory, a processor, a computer-readable storage medium, a storage medium, a communication device, a port, a client, and an interface capable of accessing other servers over wired/wireless networks. Furthermore, the method, instructions, or code for paying a commodity using a device may also be executed by a server. Other devices required to execute the method for paying a commodity using a device may be implemented as part of a hierarchical structure associated with the server.

Furthermore, the server may provide an interface to other devices including a client, another server, a printer, a database server, a print server, a file server, communication a server, and a distributed server without limitation. A connection through the interface may enable a program to be easily executed at a remote place over wired/wireless networks. Furthermore, any one of devices connected to the server through the interface may further include at least one storage device capable of storing the method, instructions or code for paying a commodity using a device. The central processor of the server may provide instructions, code, etc. to be executed on another device to the device so that the instructions, code, etc. are stored in a storage device.

The method and server for paying a commodity using a device, which have been described in this specification, may be used partially or generally through network infrastructure. In this case, the network infrastructure may include all of devices, such as a computing device, a server, a router, a hub, a firewall, a client, a personal computer, a communication device, and a routing device, and separate modules capable of executing respective functions. The network infrastructure may further include storage media, such as story flash memory, a buffer, a stack, RAM, and ROM, in addition to the aforementioned devices and module. Furthermore, the method, instructions or code for paying a commodity using a device may also be executed by and stored in any one of the device, module, and storage medium included in the network infrastructure. Another device required to execute the method for paying a commodity using a device may also be implemented as part of the network infrastructure.

Furthermore, the method and server for paying a commodity using a device, which have been described in this specification, may be implemented using hardware or hardware suitable for a specific application and software. In this case, the hardware includes all of general-purpose computer devices, such as a personal computer and a mobile communication terminal, and a business type specific computer device. The computer device may be implemented using a device, such as memory, a microprocessor, a microcontroller, a digital signal processor, an application-specific integrated circuit, a programmable gate array, programmable array logic or a combination of them.

The aforementioned computer software, instructions, code, etc. may be stored or accessed by a readable device. In this case, the readable device may include memory, such as a computer component including digital data used for computing for a specific time, semiconductor storage, such as RAM or ROM, permanent storage, such as an optical disk, high-capacity storage, such as a hard disk, a tape and a drum, optical storage, such as a CD or DVD, and network access type storage, such as flash memory, a floppy disk, a magnetic tape, a paper tape, an independent type RAM disk, high-capacity storage detachable from a computer, dynamic memory, static memory, variable storage, and cloud. In this case, the instructions, code, etc. include all of languages, such as data-oriented languages, such as SQL and dBase, system languages, such as C, Objective C, C++, and Assembly, architecture languages, such as Java and NET, and application languages, such as PHP, Ruby, Perl, and Python, but are not limited thereto. The instructions, code, etc. may include all of languages widely known to those skilled in the art to which the present invention pertains.

Furthermore, the “computer-readable medium” described in this specification includes all of media which contribute to the provision of instruction to a processor in order to execute a program. More specifically, the “computer-readable medium” includes non-volatile media, such as a data storage device, an optical disk and a magnetic disk, volatile media, such as dynamic memory, and transmission media, such as a coaxial cable, a copper wire and an optical fiber for sending data, but is not limited thereto.

The elements for executing the technical characteristics of the present invention included in the block diagrams and flowcharts shown in the accompanying drawings of this specification mean the logical boundary between the elements.

In accordance with software or hardware embodiments, however, the functions of the illustrated elements and functions thereof may be implemented so that the elements and functions thereof are executed in the form of an independent software module, a monolithic software structure, code, a service or a combination of them and are stored in a medium which is executable by a computer including a processor capable of executing stored program code and instructions. Accordingly, all of such embodiments should be construed as belonging to the scope of the present invention.

Accordingly, the accompanying drawings and technologies thereof describe the technical characteristics of the present invention, but should not be simply reasoned unless a specific array of software for implementing such technical characteristics is clearly described otherwise. That is, the aforementioned various embodiments may be present and may be partially modified while having the same technical characteristics as those of the present invention. Accordingly, such modified embodiments should be construed as belonging to the scope of the present invention.

Furthermore, the flowchart describes operations in the drawing in a specific sequence, but has been illustrated to obtain the most preferred results. It should not be understood that such operations must be executed or all the illustrated operations must be executed in the illustrated specific sequence or sequential order. In a specific case, multi-tasking and parallel processing may be advantageous. Furthermore, the separation of various system components in the aforementioned embodiments should not be construed as requesting such separation in all the embodiments. It should be understood that the aforementioned program components and systems may be integrated into a single software product or packaged into a multi-software product.

In accordance with the embodiments of the present invention, a gesture of a user who selects a commodity through the device can be automatically selected, the commodity can be put in a shopping basket, and payment for the commodity can be performed. Accordingly, there is an advantage in that a user can easily purchase a commodity without renting a cart.

Furthermore, in paying a commodity, additional information, such as a corresponding coupon and membership points applied to the commodity, can be provided to a user. Accordingly, a substantial help can be provided in the purchase of a commodity, and a company which provides corresponding information can have a kind of marketing effect.

Advantages of the following embodiments are not limited to the aforementioned advantages, and various other advantages may be evidently understood by those skilled in the art to which the embodiments pertain from the following description.

As described above, the detailed terms proposed in this specification are not intended to limit the present invention. Accordingly, although the present invention has been described in detail with reference to the aforementioned embodiments, those skilled in the art to which the present invention pertains may reconstruct, change and modify the embodiments without departing from the scope of the present invention.

The scope of the present invention is defined by the appended claims rather than the detailed description, and the present invention should be construed as covering all modifications or variations derived from the meaning and scope of the appended claims and their equivalents.

What is claimed is:

1. A method for paying a commodity using a device, comprising:
(a) obtaining commodity information by scanning barcode of a commodity;
(b) recognizing a first gesture of a user;
(c) sending the obtained commodity information to a server in response to the recognized first gesture; and
(d) receiving purchase information about the commodity whose commodity information has been obtained from the server and outputting the purchase information.

2. The method of claim 1, wherein the first gesture comprises a gesture which has been previously set and stored and which is indicative of an expression of the user's intentions of adding the commodity to a shopping basket.

3. The method of claim 2, further comprising steps of:
(c-1) adding, by the server, the commodity whose commodity information has been obtained to the shopping basket of the user after the step (c); and
(c-2) outputting the shopping basket of the user.

4. The method of claim 1, wherein the purchase information comprises information about one or more of a name, price, selling place, purchase quantity, applied coupon, and applied membership points of the commodity.

5. The method of claim 1, further comprising a step of (e) recognizing, by a device, a second gesture of the user after the step (d).

6. The method of claim 5, wherein the second gesture comprises a gesture which has been previously set and stored and which is indicative of an expression of the user's intentions of deleting the commodity from the shopping basket.

7. The method of claim 6, further comprising a step of (e-1) deleting, by the server, the commodity whose commodity information has been obtained from the shopping basket of the user after the step (e).

8. The method of claim 4, further comprising steps of:
(f) receiving a payment request from the user after the step (d); and
(g) sending the payment request for the commodity whose purchase information has been obtained to the server.

9. The method of claim 8, wherein the step (f) comprises steps of:
(f-1) receiving one or more selected from a coupon and membership points applied to the commodity whose purchase information has been obtained; and
(f-2) receiving a delivery address to which the commodity whose purchase information has been obtained is to be delivered.
